(19) United States
(12) Patent Application Publication
(10) Pub. No.: US 2023/0185353 A1
(43) Pub. Date: Jun. 15, 2023

(54) PRINTER WITH SENSOR CIRCUIT HAVING ADJUSTABLE THRESHOLD

(71) Applicant: HEWLETT-PACKARD DEVELOPMENT COMPANY, L.P., Spring, TX (US)

(72) Inventors: Robert G. Mejia; David Lance Spaulding, Boise, ID (US)

(73) Assignee: HEWLETT-PACKARD DEVELOPMENT COMPANY, L.P., Spring, TX (US)

(21) Appl. No.: 17/551,461

(22) Filed: Dec. 15, 2021

(51) Int. Cl. B41J 29/38

(52) U.S. Cl. CPC B41J 29/38

(57) ABSTRACT

A printer, according to an example, includes a sensor circuit to sense a position of an element of the printer, wherein the sensor circuit includes a comparison circuit to compare a sensed signal to a threshold signal and generate an output signal based on the comparison. The printer includes a controller to: repeatedly power on and power off the sensor circuit; receive the output signal of the comparison circuit when the sensor circuit is powered on, thereby receiving a plurality of output signals over time; and adjust the threshold signal based on at least one of the plurality of output signals.

### BACKGROUND

A printer may use optical sensors to determine positioning of movable mechanical parts in the printer. Some of these sensors may be used in sleep modes in order to wake the printer from sleep.

### BRIEF DESCRIPTION OF THE DRAWINGS

FIG. 1 is a block diagram illustrating a fluid ejection system according to an example.

FIG. 2 is a schematic diagram illustrating additional detail of the sensor circuit shown in FIG. 1 according to an example.

FIG. 3 is a diagram illustrating signals used in the sensor circuit shown in FIG. 2 according to an example.

FIG. 4 is a block diagram illustrating a printer according to an example.

FIG. 5 is a flow diagram illustrating a method of controlling a sensor circuit of a printer according to an example.

FIG. 6 is a block diagram illustrating a printer according to another example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

A printer may use optical sensors to determine the positioning of movable parts in the printer. Some of these sensors may be used in sleep modes in order to wake the printer from sleep. Some optical sensors may use sixty milliwatts or more of power. A printer in a sleep mode may not be able to tolerate this amount of power consumption during the sleep mode. For this reason, the optical sensors may be powered off most of the time and be briefly powered on two or three times a second, for example, to obtain a sensor reading. The duty cycle for powering up an optical sensor in a printer may be a few percent, which reduces the power consumption of the optical sensor.

Some sensor circuits may perform a comparison between a sensor signal and a threshold signal, and have an output that transitions back and forth between a low state and a high state. If a sensor is noisy, prone to drift, or moves slowly, it may make many threshold crossings as it transitions from a low state to a high state. Without hysteresis, this may cause a number of unwanted state changes in the system. These extra signal transitions can cause a number of undesired behaviors.

Examples in this disclosure are directed to a printer with an optical sensing circuit that senses the position of a movable part of the printer. To save power, the optical sensing circuit may be powered off most of the time, and is briefly powered on a few times a second to provide sensor output signals to a microcontroller. The optical sensing circuit may include a comparator that compares a sensed signal to a threshold signal, and outputs a sensor output signal to the microcontroller based on the comparison. In order to help eliminate undesired threshold crossings (e.g., caused by noise) of the optical sensing circuit, hysteresis may be implemented by the microcontroller by storing previous values of the sensor signals output by the optical sensing circuit, and adjusting the threshold signal of the comparator based on the stored values. In order to implement hysteresis in a sensor circuit of a system that power cycles the sensor circuit to save power, the system may use a low power (e.g., about 10 microwatt power consumption) to record a previous value read from a sensor circuit while the sensor circuit is powered off.

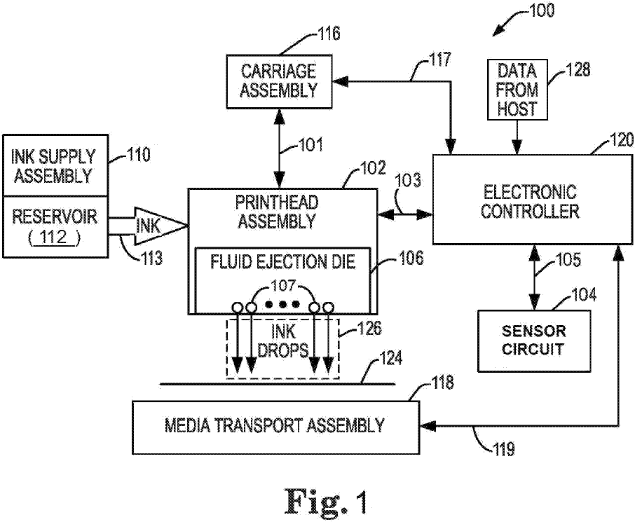

FIG. 1 is a block diagram illustrating a fluid ejection system 100 according to an example. Fluid ejection system 100 includes a fluid ejection assembly, such as printhead assembly 102, and a fluid supply assembly, such as ink supply assembly 110. In an example, printhead assembly 102 may include a fluid ejection device. In the illustrated example, fluid ejection system 100 also includes a sensor circuit 104, a carriage assembly 116, a print media transport assembly 118, and an electronic controller 120. While the following description provides examples of systems and assemblies for fluid handling with regard to ink, the disclosed systems and assemblies are also applicable to the handling of fluids other than ink.

Printhead assembly 102 includes at least one printhead or fluid ejection die 106, which ejects drops of ink or fluid through a plurality of orifices or nozzles 107. In one example, the drops are directed toward a medium, such as print media 124, so as to print onto print media 124. In one example, print media 124 includes any type of suitable sheet material, such as paper, card stock, transparencies, Mylar, fabric, and the like. In another example, print media 124 includes media for three-dimensional (3D) printing, such as a powder bed, or media for bioprinting and/or drug discovery testing, such as a reservoir or container. In an example, nozzles 107 are arranged in at least one column or array such that properly sequenced ejection of ink from nozzles 107 causes characters, symbols, and/or other graphics or images to be printed upon print media 124 as printhead assembly 102 and print media 124 are moved relative to each other.

Ink supply assembly 110 supplies ink to printhead assembly 102 and includes a reservoir 112 for storing ink. As such, in one example, ink flows from reservoir 112 to printhead assembly 102. In one example, printhead assembly 102 and ink supply assembly 110 are housed together in an inkjet or fluid-jet print cartridge or pen. In another example, ink supply assembly 110 is separate from printhead assembly 102 and supplies ink to printhead assembly 102 through an interface connection 113, such as a supply tube and/or valve.

Carriage assembly 116 positions printhead assembly 102 relative to print media transport assembly 118, and print media transport assembly 118 positions print media 124 relative to printhead assembly 102. Thus, a print zone 126 is defined adjacent to nozzles 107 in an area between printhead assembly 102 and print media 124. In one example, printhead assembly 102 is a scanning type printhead assembly such that carriage assembly 116 moves printhead assembly 102 relative to print media transport assembly 118. In another example, printhead assembly 102 is a non-scanning type printhead assembly such that carriage assembly 116 fixes printhead assembly 102 at a prescribed position relative to print media transport assembly 118.

Sensor circuit 104 provides sensor output signals to electronic controller 120 to indicate the position of a moving object within system 100. The sensor circuit 104 may include a comparator that compares a sensed signal to a threshold signal, and outputs a sensor output signal to the electronic controller 120 based on the comparison. In some examples, hysteresis is implemented by the electronic controller 120 by storing previous values of the sensor signals output by the sensor circuit 104, and the electronic controller 120 adjusts the threshold signal of the comparator based on the stored values. In an example, sensor circuit 104 is an optical sensor circuit.

Electronic controller 120 communicates with printhead assembly 102 through a communication path 103, sensor circuit 104 through a communication path 105, carriage assembly 116 through a communication path 117, and print media transport assembly 118 through a communication path 119. In an example, when printhead assembly 102 is mounted in carriage assembly 116, electronic controller 120 and printhead assembly 102 may communicate via carriage assembly 116 through a communication path 101. Electronic controller 120 may also communicate with ink supply assembly 110 such that, in an example, a new (or used) ink supply may be detected.

Electronic controller 120 receives data 128 from a host system, such as a computer, and may include memory for temporarily storing data 128. Data 128 may be sent to fluid ejection system 100 along an electronic, infrared, optical or other information transfer path. Data 128 represent, for example, a document and/or file to be printed. As such, data 128 form a print job for fluid ejection system 100 and includes at least one print job command and/or command parameter.

In an example, electronic controller 120 provides control of printhead assembly 102 including timing control for ejection of ink drops from nozzles 107. As such, electronic controller 120 defines a pattern of ejected ink drops which form characters, symbols, and/or other graphics or images on print media 124. Timing control and, therefore, the pattern of ejected ink drops, is determined by the print job commands and/or command parameters. In an example, logic and drive circuitry forming a portion of electronic controller 120 may be located on printhead assembly 102. In another example, logic and drive circuitry forming a portion of electronic controller 120 may be located off printhead assembly 102. In other examples, system 100 may be another type of system for forming characters, symbols, and/or other graphics or images on print media 124, such as a laser printer.

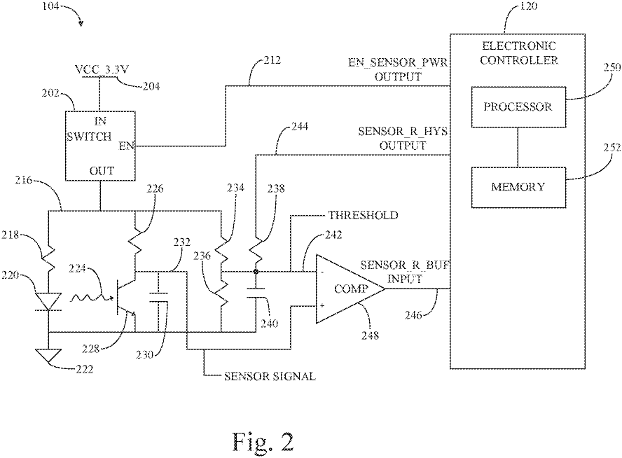

FIG. 2 is a schematic diagram illustrating additional detail of the sensor circuit 104 shown in FIG. 1 according to an example. Sensor circuit 104 includes electronic switch 202, resistor 218, light emitting diode (LED) 220, resistor 226, phototransistor 228, capacitor 230, resistor 234, resistor 236, resistor 238, capacitor 240, and comparator 248. Electronic controller 120 is coupled to an enable (EN) input of electronic switch 202 via communication link 212, and controls the electronic switch 202 with an EN_SENSOR_PWR output signal. An input (IN) of the electronic switch 202 is coupled to a power supply line (VCC_3.3V) 204. An output (OUT) of the electronic switch 202 is coupled to sensor supply line 216. The electronic controller 120 may use the EN_SENSOR_PWR output signal to cause the switch 202 to selectively connect/disconnect the sensor supply line 216 to/from the power supply line 204, and thereby selectively power on and power off the sensor circuitry. In an example, in a sleep mode of the printer 100, the sensor circuitry is powered off most of the time, and the electronic controller 120 briefly powers on the sensor circuitry at fixed intervals (e.g., 2-3 times a second) for a brief time window to take a sensor reading during each time window.

In an example, electronic controller 120 is a low power microcontroller that includes a processor 250 and memory 252. Processor 250 includes a Central Processing Unit (CPU) or another suitable processor. In an example, memory 252 stores machine readable instructions executed by processor 250 for operating controller 120. Memory 252 includes any suitable combination of volatile and/or non-volatile memory, such as combinations of Random Access Memory (RAM), Read-Only Memory (ROM), flash memory, and/or other suitable memory. These are examples of non-transitory computer readable storage media. The memory 252 is non-transitory in the sense that it does not encompass a transitory signal but instead is made up of a memory component to store machine executable instructions for performing techniques described herein.

Resistor 218 and LED 220 are coupled in series with each other between sensor supply line 216 and ground 222. Resistor 218 is used to limit the current through the LED 220. Resistor 226 and phototransistor 228 are coupled in series with each other between sensor supply line 216 and ground 222, and are coupled in parallel with the series connected resistor 218 and LED 220. Resistor 226 is used to bias the phototransistor 228. Resistors 234 and 236 are coupled in series with each other between sensor supply line 216 and ground 222, and are coupled in parallel with the series connected resistor 226 and phototransistor 228.

The collector of phototransistor 228 is coupled to resistor 226. The emitter of phototransistor 228 is coupled to ground. LED 220 emits light 224 that is sensed by phototransistor 228. The phototransistor 228 alters the current flowing between its emitter and collector based on the level of light 224 it receives from LED 220. Phototransistor 228 may be used to sense the position of a movable object of system 100, such as a touch screen display that may be slid by a user into and out of the system 100. The movable object may block more light to phototransistor 228 from LED 220 in a first position of the object, and the movable object may block less light to phototransistor 228 from LED 220 in a second position of the object. An output line 232 is coupled to the collector of the phototransistor 228 and is also coupled to a positive input of comparator 248. The output line 232 delivers a sensor signal to the comparator that varies based on the amount of light sensed by phototransistor 228. A capacitor 230 is coupled between the output line 232 and ground 222. Capacitor 230 is used to suppress noise.

A threshold line 242 is coupled to a node between resistors 234 and 236, and is also coupled to a negative input of comparator 248. Electronic controller 120 is coupled to one end of resistor 238 via communication link 244, and the other end of resistor 238 is coupled to the threshold line 242. The threshold line 242 is coupled to ground 222 via capacitor 240. Capacitor 240 is used to suppress noise. Threshold line 242 provides a threshold signal to the negative input of comparator 248. Resistors 234 and 236 form a voltage divider that helps to set the value of a static portion of the threshold signal on threshold line 242. Electronic controller 120 may modify the threshold signal on threshold line 242 with a SENSOR_R_HYS output signal on communication link 244. Thus, the threshold signal on threshold line 242 includes both a static portion based on the values of resistors 234 and 236, as well as a dynamic portion controlled by the value of resistor 238 and the value of the SENSOR_R_HYS signal output by electronic controller 120. The relative values of resistors 234, 236, and 238 determine the amount of hysteresis.

Comparator 248 continually compares the sensor signal on line 232 with the threshold signal on line 242, and generates a binary output signal SENSOR_R_BUF that is provided as an input via communication link 246 to electronic controller 120. In an example, comparator 248 outputs a high value (i.e., logic “1”) when the sensor signal on output line 232 is greater than the threshold signal on threshold line 242, and outputs a low value (i.e., logic “0”) when the sensor signal on output line 232 is less than the threshold signal on threshold line 242.

In an example, electronic controller 120 causes the powering on of the sensor circuit 104 during each of a plurality of time windows, and causes the powering off of the sensor circuit 104 at the end of each of the time windows. For each of the time windows, the comparator 248 compares the sensed signal on line 232 during that time window to the threshold signal on line 242, and generates an output signal (SENSOR_R_BUF) based on the comparison, thereby generating a plurality of output signals respectively corresponding to the plurality of time windows. In an example, each of the outputs signals is stored in memory 252 when it is provided to controller 120. The output signal for the current time window is used by controller 120 to determine the value of the SENSOR_R_HYS signal to be output on communication link 244 for the next time window. In an example, for each time window, controller 120 causes the SENSOR_R_HYS signal for the next time window to be the inverse of the output signal for the current time window. Thus, if the stored value of the output signal for the current time window is a low value, the controller 120 causes the SENSOR_R_HYS signal for the next time window to be a high value. If the stored value of the output signal for the current time window is a high value, the controller 120 causes the SENSOR_R_HYS signal for the next time window to be a low value.

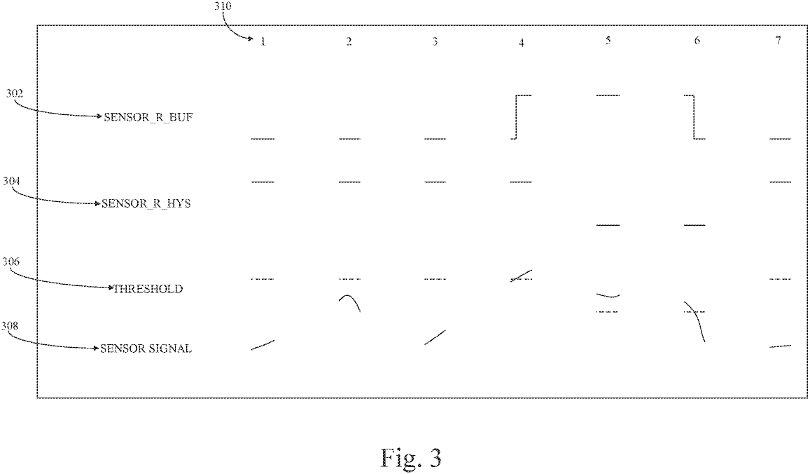

FIG. 3 is a diagram illustrating signals used in the sensor circuit 104 shown in FIG. 2 according to an example. The SENSOR_R_BUF signal 302 represents the signal output by comparator 248 to controller 120 via communication link 246. The SENSOR_R_HYS signal 304 represents the signal output by controller 120 via communication link 244. The THRESHOLD signal 306 represents the signal provided on line 242 to the negative input of comparator 248. The SENSOR SIGNAL 308 represents the signal provided on line 232 to the positive input of comparator 248. The signals 302-308 are shown in seven discrete time windows 310 (numbered 1-7), which correspond to the times that the sensor circuit 104 is powered on. The ratio of on to off time has been changed in FIG. 3 to make the figure easier to read and understand.

As shown in FIG. 3, in windows 1 through 3, the SENSOR SIGNAL 308 is below the THRESHOLD signal 306, so the SENSOR_R_BUF signal 302 output by the comparator 248 is low, and these values are stored in memory 252. For each of the windows 1-3, the SENSOR_R_BUF signal 302 for the previous window is in a low state, so the controller 120 drives the SENSOR_R_HYS signal 304 to a high state for that window in order to elevate or maintain high the THRESHOLD signal 306.

In window 4, the SENSOR SIGNAL 308 rises above the THRESHOLD signal 306, which causes the SENSOR_R_BUF signal 302 to transition to a high state. This high value of the SENSOR_R_BUF signal 302 is stored in memory 252 for use with the next window (i.e., window 5).

In window 5, the controller 120 checks the memory 252 and finds that the value of the SENSOR_R_BUF signal 302 for the previous window (i.e., window 4) was a high value, and in response, drives a low value out for the SENSOR_R_HYS signal 304. The low value for the SENSOR_R_HYS signal 304 causes the THRESHOLD signal 306 to be lowered by controller 120 in window 5. The SENSOR SIGNAL 308 in window 5 falls to about the same level as it was in window 2, but it does not fall below the THRESHOLD signal 306, so the SENSOR_R_BUF signal 302 remains high.

In window 6, the controller 120 checks the memory 252 and finds that the value of the SENSOR_R_BUF signal 302 for the previous window (i.e., window 5) was a high value, and in response, drives a low value out for the SENSOR_R_HYS signal 304. The low value for the SENSOR_R_HYS signal 304 causes the THRESHOLD signal 306 to be lowered by controller 120 in window 6. In window 6, the SENSOR SIGNAL 308 falls below the THRESHOLD signal 306, so the SENSOR_R_BUF signal 302 transitions to a low value, which is stored in memory 252.

In window 7, the controller 120 checks the memory 252 and finds that the value of the SENSOR_R_BUF signal 302 for the previous window (i.e., window 6) was a low value, and in response, drives a high value out for the SENSOR_R_HYS signal 304. The high value for the SENSOR_R_HYS signal 304 causes the THRESHOLD signal 306 to be raised by controller 120 in window 7. In window 7, the SENSOR SIGNAL 308 stays below the THRESHOLD signal 306, so the SENSOR_R_BUF signal 302 remains at a low value, which is stored in memory 252.

In an example, controller 120 uses two timers to define two time intervals for each of the time windows shown in FIG. 3. When the first timer expires, the controller 120 powers on the sensor circuit 104 and sets the SENSOR_R_HYS signal 304 to be the inverse of the SENSOR_R_BUF signal 302 for the previous window. The controller 120 then resets the timer to give the signals time to stabilize. When the timer expires the second time, the controller 120 then reads the state of the SENSOR_R_BUF signal 302 for the next time window.

In other example of sensor circuit 104, comparator 248 may not be used, and the controller 120 may read the analog values of the sensor outputs when the circuit 104 is powered up to take a reading. Controller 120 may maintain a short history of the analog values, and may use a variable that reflects the current state of the sensed value. When the next value of the sensor output is read, the value of the current state of the variable can be used to determine if the new value has changed enough for the current state of the system to change. For example, the current state may have two values, high and low. When the current state is high, the threshold can be set to VTHhigh, and when the current state is low, the threshold can be set to VTHlow. Note that VTHhigh is a lower value than VTHlow. If the current state is HIGH and the threshold is set to VTHhigh, then the current state would not change until there is a sensor reading lower than VTHhigh. Once this occurs, the current state is changed to LOW and the threshold is changed to VTHlow (which is higher than VTHhigh). The current state will now remain low until there is a sensor reading at a value higher than VTHlow.

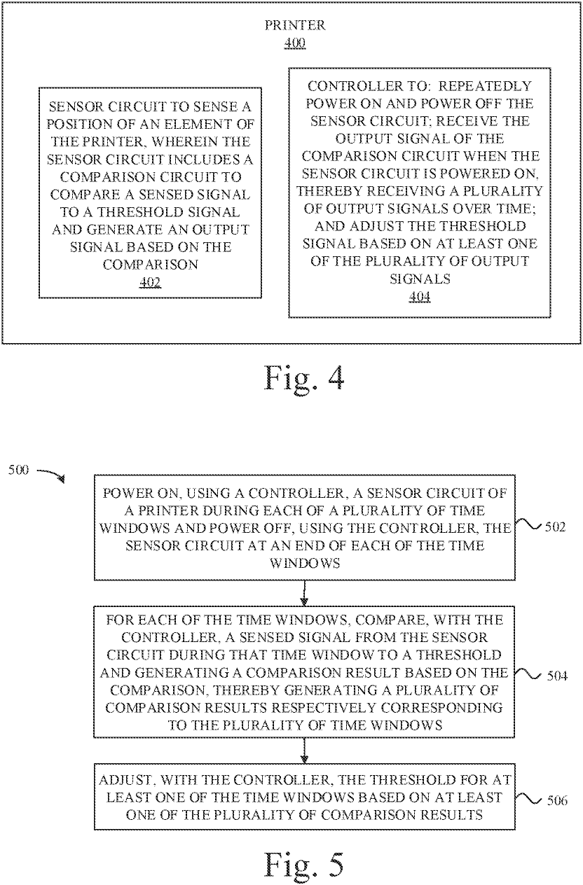

An example of the present disclosure is directed to a printer. FIG. 4 is a block diagram illustrating a printer 400 according to an example. Printer 400 includes a sensor circuit 402 to sense a position of an element of the printer, wherein the sensor circuit includes a comparison circuit to compare a sensed signal to a threshold signal and generate an output signal based on the comparison. The printer 400 includes a controller 404 to: repeatedly power on and power off the sensor circuit; receive the output signal of the comparison circuit when the sensor circuit is powered on, thereby receiving a plurality of output signals over time; and adjust the threshold signal based on at least one of the plurality of output signals.

In an example of printer 400, the controller 404 may adjust the threshold signal based on at least one of the plurality of output signals to provide hysteresis for the comparison circuit. The controller 404 may store a plurality of output values respectively corresponding to the plurality of outputs of the comparison circuit. The sensor circuit 402 may be powered on for each of a plurality of time windows, and the controller 404 may adjust the threshold signal for a current one of the time windows based on a stored one of the plurality of output values for a previous one of the time windows. The sensor circuit 402 may increase the threshold signal for the current one of the time windows when the stored one of the plurality of output values for the previous one of the time windows is a low value, and the sensor circuit 402 may decrease the threshold signal for the current one of the time windows when the stored one of the plurality of output values for the previous one of the time windows is a high value.

The controller 404 may repeatedly power on and power off the sensor circuit 402 during a sleep mode of the printer 400. The printer 400 may include a switch circuit coupled to the controller 404 and the sensor circuit 402 to power on and power off the sensor circuit 402 under the control of the controller 404. The sensor circuit 402 may include a light emitting diode to generate light and a phototransistor to sense the light from the light emitting diode and generate the sensed signal. The comparison circuit may include a comparator with a first input to receive the threshold signal, a second input to receive the sensed signal, and an output to provide the plurality of output signals. The threshold signal may include a static portion that is based on a power supply and resistor values of the sensor circuit 402, and a dynamic portion that is provided by the controller 404.

Another example of the present disclosure is directed to a method of controlling a sensor circuit of a printer. FIG. 5 is a flow diagram illustrating a method 500 of controlling a sensor circuit of a printer according to an example. Method 500 includes, at 502, powering on, using a controller, a sensor circuit of a printer during each of a plurality of time windows and powering off, using the controller, the sensor circuit at an end of each of the time windows. The method 500 includes, at 504, for each of the time windows, comparing, with the controller, a sensed signal from the sensor circuit during that time window to a threshold and generating a comparison result based on the comparison, thereby generating a plurality of comparison results respectively corresponding to the plurality of time windows. The method 500 includes, at 506, adjusting, with the controller, the threshold for at least one of the time windows based on at least one of the plurality of comparison results.

The method 500 may further include adjusting the threshold for a current one of the time windows based on one of the comparison results for a previous one of the time windows. The method 500 may further include increasing the threshold for the current one of the time windows when the comparison result for the previous one of the time windows has transitioned to a low value; and decreasing the threshold for the current one of the time windows when the comparison result for the previous one of the time windows has transitioned to a high value.

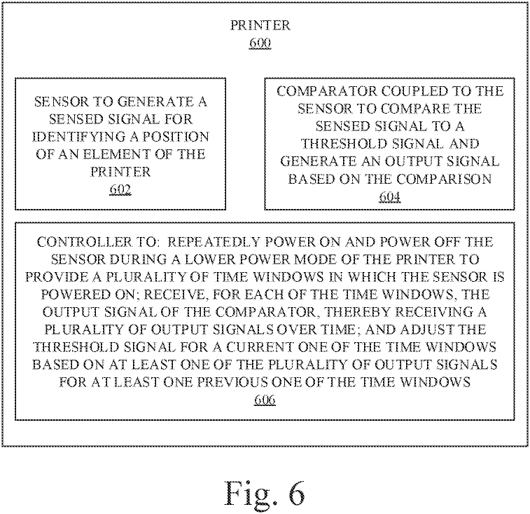

Another example of the present disclosure is directed to a printer. FIG. 6 is a block diagram illustrating a printer 600 according to another example. Printer 600 includes a sensor 602 to generate a sensed signal for identifying a position of an element of the printer. Printer 600 includes a comparator 604 coupled to the sensor 602 to compare the sensed signal to a threshold signal and generate an output signal based on the comparison. The printer 600 includes a controller 606 to: repeatedly power on and power off the sensor 602 during a lower power mode of the printer 600 to provide a plurality of time windows in which the sensor 602 is powered on; receive, for each of the time windows, the output signal of the comparator 604, thereby receiving a plurality of output signals over time; and adjust the threshold signal for a current one of the time windows based on at least one of the plurality of output signals for at least one previous one of the time windows.

The controller 606 may repeatedly adjust the threshold signal to provide hysteresis for the comparator.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A printer, comprising:
a sensor circuit to sense a position of an element of the printer, wherein the sensor circuit includes a comparison circuit to compare a sensed signal to a threshold signal and generate an output signal based on the comparison; and
a controller to:
repeatedly power on and power off the sensor circuit;
receive the output signal of the comparison circuit when the sensor circuit is powered on, thereby receiving a plurality of output signals overtime; and
adjust the threshold signal based on at least one of the plurality of output signals.

2. The printer of claim 1, wherein the controller is to adjust the threshold signal based on at least one of the plurality of output signals to provide hysteresis for the comparison circuit.

3. The printer of claim 1, wherein the controller is to store a plurality of output values respectively corresponding to the plurality of outputs of the comparison circuit.

4. The printer of claim 3, wherein the sensor circuit is powered on for each of a plurality of time windows, and wherein the controller is to adjust the threshold signal for a current one of the time windows based on a stored one of the plurality of output values for a previous one of the time windows.

5. The printer of claim 4, wherein the sensor circuit is to increase the threshold signal for the current one of the time windows when the stored one of the plurality of output values for the previous one of the time windows is a low value, and wherein the sensor circuit is to decrease the threshold signal for the current one of the time windows when the stored one of the plurality of output values for the previous one of the time windows is a high value.

6. The printer of claim 1, wherein the controller is to repeatedly power on and power off the sensor circuit during a sleep mode of the printer.

7. The printer of claim 1, and further comprising a switch circuit coupled to the controller and the sensor circuit to power on and power off the sensor circuit under the control of the controller.

8. The printer of claim 1, wherein the sensor circuit comprises a light emitting diode to generate light and a phototransistor to sense the light from the light emitting diode and generate the sensed signal.

9. The printer of claim 8, wherein the comparison circuit includes a comparator with a first input to receive the threshold signal, a second input to receive the sensed signal, and an output to provide the plurality of output signals.

10. The printer of claim 9, wherein the threshold signal comprises a static portion that is based on a power supply and resistor values of the sensor circuit, and a dynamic portion that is provided by the controller.

11. A method, comprising:
powering on, using a controller, a sensor circuit of a printer during each of a plurality of time windows and powering off, using the controller, the sensor circuit at an end of each of the time windows;
for each of the time windows, comparing, with the controller, a sensed signal from the sensor circuit during that time window to a threshold and generating a comparison result based on the comparison, thereby generating a plurality of comparison results respectively corresponding to the plurality of time windows; and
adjusting, with the controller, the threshold for at least one of the time windows based on at least one of the plurality of comparison results.

12. The method of claim 11, and further comprising:
adjusting the threshold for a current one of the time windows based on one of the comparison results for a previous one of the time windows.

13. The method of claim 12, and further comprising:
increasing the threshold for the current one of the time windows when the comparison result for the previous one of the time windows has transitioned to a low value; and
decreasing the threshold for the current one of the time windows when the comparison result for the previous one of the time windows has transitioned to a high value.

14. A printer, comprising:
a sensor to generate a sensed signal for identifying a position of an element of the printer;
a comparator coupled to the sensor to compare the sensed signal to a threshold signal and generate an output signal based on the comparison; and
a controller to:
repeatedly power on and power off the sensor during a lower power mode of the printer to provide a plurality of time windows in which the sensor is powered on;
receive, for each of the time windows, the output signal of the comparator, thereby receiving a plurality of output signals over time; and
adjust the threshold signal for a current one of the time windows based on at least one of the plurality of output signals for at least one previous one of the time windows.

15. The printer of claim 14, wherein the controller is to repeatedly adjust the threshold signal to provide hysteresis for the comparator.
